(19) United States
(12) Patent Application Publication
(10) Pub. No.: US 2026/0039683 A1
(43) Pub. Date: Feb. 5, 2026

(54) METHOD AND SYSTEM FOR ANALYSING AND MITIGATING SECURITY RISKS IN OPEN INNOVATION ECOSYSTEM

(71) Applicants: Umar Safdar, Al Buraimi (OM); Imran Saleem, Al Buraimi (OM); Saleem Basha Mohamed Sulaiman, Al Buraimi (OM); University of Buraimi, Al Buraimi (OM)

(72) Inventors: Umar Safdar, Al Buraimi (OM); Imran Saleem, Al Buraimi (OM); Saleem Basha Mohamed Sulaiman, Al Buraimi (OM)

(21) Appl. No.: 19/355,683

(22) Filed: Oct. 10, 2025

(51) Int. Cl. H04L 9/40

(52) U.S. Cl. CPC H04L 63/1433

(57) ABSTRACT

A method and system for analysing and mitigating security risks in open innovation ecosystem is disclosed. The system comprises detects potential vulnerabilities in open innovation activities, including intellectual property exchanges, research data handling, and partner collaboration processes to provide identified threat data as input. The system represents interactions between an innovator and an adversary as a two-player zero-sum game. The system computes Nash equilibrium from the payoff matrix. The Nash equilibrium represents optimal defensive investments under adversarial conditions. The system also models adversary uncertainty using probability distributions, and further updates the equilibrium strategies based on incomplete or dynamic information. The system, thereafter, evaluates adversary uncertainty using Entropy-based risk assessment to determine levels of security investment resources responsive to the quantified uncertainty. Finally, the system integrates results of the equilibrium analysis, probabilistic inference, and uncertainty quantification to generate actionable security recommendations and guidelines for mitigation strategies.

### FIELD

Various embodiments of the present disclosure generally relate to open innovation ecosystem. More particularly, the disclosure relates to a method and system for analysing and mitigating security risks in open innovation ecosystem.

### BACKGROUND

In contemporary open innovation environments, where organizations, innovators, collaborators, and external partners exchange knowledge and resources, significant security challenges arise. Such environments are particularly vulnerable to risks including intellectual property theft, data breaches, and other forms of exploitation by adversarial entities. Conventional security measures typically adopt static approaches in which defensive resources are allocated without accounting for the strategic and adaptive nature of potential adversaries. This often results in underinvestment in critical areas or misallocation of resources, thereby leaving essential assets exposed. These vulnerabilities not only endanger organizational competitiveness but also create broader risks to national innovation ecosystems. Accordingly, there is a need for rigorous and systematic approaches that enable the optimal allocation of security investments in the face of evolving and uncertain threats.

Open innovation paradigms whereby firms, inventors, universities, collaborators, and external partners jointly engage in research, development, and commercialization accelerate knowledge exchange and technological progress. However, the very openness of these models increases exposure to adversarial exploitation. Sensitive technical data, prototypes, and intellectual property shared across multiple parties create persistent opportunities for attackers to compromise or misappropriate valuable assets. Static or siloed security practices such as perimeter defenses, access control lists, and reactive incident responses are insufficient to address these challenges. Because adversaries often act strategically and adaptively, defenders relying solely on fixed measures risk both over-investment in low-value areas and under-protection of high-value assets.

Another limitation of many current security assessment frameworks is the lack of rigorous treatment of uncertainty in adversary behavior. In real-world contexts, defenders operate with incomplete information about attacker goals, resources, or tactics. Deterministic scoring models and static risk matrices do not capture the probabilistic nature of adversarial decision making, nor do they update as new intelligence becomes available. This creates blind spots in risk assessment and undermines the ability of innovators and collaborators to respond effectively to emerging threats.

While game-theoretic models have been proposed to represent strategic attacker-defender interactions, many prior approaches remain largely theoretical, lack integration with operational data sources, or fail to produce actionable guidance for investment allocation. Similarly, although probabilistic inference techniques such as Bayesian analysis can represent uncertainty in adversary types and behaviors, they are rarely combined with decision models that optimize trade-offs between investment costs and expected loss. Information-theoretic measures, including entropy, provide useful tools to quantify uncertainty and unpredictability in attacker strategies, yet these metrics are underutilized in practical systems for guiding defensive planning.

Current systems therefore often overlook the uncertainty in adversary behavior and lack integration with probabilistic models and entropy-based measurements. Without such integration, security assessments remain incomplete and do not yield robust, cost-sensitive recommendations. An improved open innovation security framework should account for adversary strategies, model probabilistic behavior, and quantify uncertainty to provide innovators and collaborators with insights for allocating security investments more effectively.

Hence, there is a growing need for advanced systems that go beyond static security measures and incorporate rigorous analytical methods to address the dynamic and uncertain nature of adversarial behavior in open innovation environments. In particular, approaches that integrate strategic modeling of attacker-defender interactions, probabilistic reasoning under incomplete information, and quantitative measures of uncertainty would enable more effective evaluation of security risks and the development of robust mitigation strategies. Such improvements are essential to support the resilience, competitiveness, and trustworthiness of open innovation ecosystems.

### SUMMARY

Various embodiments of the present disclosure generally relate to a method and system for analysing and mitigating security risks in open innovation ecosystem. The system comprises a threat identification unit which detects potential vulnerabilities in open innovation activities, including intellectual property exchanges, research data handling, and partner collaboration processes, and to provide identified threat data as input. A game-theoretic security modelling unit of the system coupled to the threat identification unit represents interactions between an innovator and an adversary as a two-player zero-sum game. The two-player zero-sum game comprises at least one payoff matrix that encodes outcomes of defensive resource allocations and adversarial actions derived from the identified threat data. An equilibrium analysis unit of the system coupled to the game-theoretic security modelling unit computes Nash equilibrium from the payoff matrix. The Nash equilibrium represents optimal defensive investments under adversarial conditions. A Bayesian risk modelling unit coupled to the equilibrium analysis unit is configured to model adversary uncertainty using probability distributions, and further updates the equilibrium strategies based on incomplete or dynamic information.

An uncertainty quantification unit coupled to the Bayesian risk modelling unit evaluates adversary uncertainty using Entropy-based risk assessment to determine levels of security investment resources responsive to the quantified uncertainty. A policy and strategy planner unit coupled to the uncertainty quantification unit integrates results of the equilibrium analysis, probabilistic inference, and uncertainty quantification to generate actionable security recommendations including allocation of security investment, prioritization of protective measures, and guidelines for mitigation strategies.

### BRIEF DESCRIPTION OF THE FIGURES

FIG. 1 is a diagram that illustrates an exemplary environment within which various embodiment of the present disclosure may function.

FIG. 2 is a diagram that illustrates a system for analysing and mitigating security risks in an open innovation ecosystem, in accordance with an embodiment of the disclosure.

FIG. 3 is a diagram that illustrates a flowchart with a method for analysing and mitigating security risks in open innovation ecosystem, in accordance with an embodiment of the disclosure.

### DETAILED DESCRIPTION

Pursuant to various embodiments, the present disclosure provides a method and system for analysing and mitigating security risks in open innovation ecosystem. The system comprises a threat identification unit which detects potential vulnerabilities in open innovation activities, including intellectual property exchanges, research data handling, and partner collaboration processes, and to provide identified threat data as input. A game-theoretic security modelling unit of the system coupled to the threat identification unit represents interactions between an innovator and an adversary as a two-player zero-sum game. The two-player zero-sum game comprises at least one payoff matrix that encodes outcomes of defensive resource allocations and adversarial actions derived from the identified threat data. An equilibrium analysis unit of the system coupled to the game-theoretic security modelling unit computes Nash equilibrium from the payoff matrix. The Nash equilibrium represents optimal defensive investments under adversarial conditions. A Bayesian risk modelling unit coupled to the equilibrium analysis unit is configured to model adversary uncertainty using probability distributions, and further updates the equilibrium strategies based on incomplete or dynamic information.

An uncertainty quantification unit coupled to the Bayesian risk modelling unit evaluates adversary uncertainty using Entropy-based risk assessment to determine levels of security investment resources responsive to the quantified uncertainty. A policy and strategy planner unit coupled to the uncertainty quantification unit integrates results of the equilibrium analysis, probabilistic inference, and uncertainty quantification to generate actionable security recommendations including allocation of security investment, prioritization of protective measures, and guidelines for mitigation strategies.

In one or more embodiments, open innovation refers to a collaborative approach to innovation in which organizations, enterprises, or individuals actively share knowledge, research data, intellectual property, and technological resources with external entities, including partners, research institutions, startups, or other innovators, in order to accelerate the development and commercialization of new products, processes, or services. Open innovation encompasses a range of activities, such as joint research and development projects, licensing of intellectual property, crowdsourcing of ideas, co-creation with customers, and collaborative problem-solving.

In one or more embodiments, the open innovation ecosystem 102 comprises innovators, collaborators, and external partners engaged in joint research, development, or intellectual property activities. These participants may include organizations, startups, academic institutions, research laboratories, or individual innovators who contribute knowledge, data, technological resources, or intellectual property to collaborative projects. The ecosystem 102 supports the coordinated exchange of information, co-creation of products or services, licensing or sharing of patents, and joint problem-solving initiatives. By enabling interaction among multiple stakeholders, the ecosystem 102 facilitates accelerated innovation, broader technological exploration, and access to expertise or resources that may not be available within a single entity. In the context of the present disclosure, interactions within the ecosystem 102 are monitored and analyzed to identify security risks, evaluate adversarial behavior, and implement mitigation strategies to protect sensitive information, research data, and intellectual property.

The term is intended to include both structured collaborations governed by formal agreements as well as informal exchanges of information or technology. By leveraging external expertise and resources, open innovation aims to reduce development cycles, increase technological diversity, enhance competitive advantage, and enable access to markets or capabilities that may be unavailable internally. In the context of the present disclosure, open innovation further includes any interaction or transaction in which sensitive information, trade secrets, or strategic data may be exposed to potential adversarial entities, thereby creating risks that require security analysis and mitigation.

In one or more embodiments, security risks in this context refer to potential threats, vulnerabilities, or exposures that could compromise the confidentiality, integrity, or availability of information, intellectual property, research data, or technological assets within an open innovation ecosystem. Such risks may arise from deliberate adversarial actions, including cyberattacks, industrial espionage, unauthorized access, or misappropriation of sensitive data, as well as from unintentional events such as human errors, system failures, or inadvertent disclosure during collaboration. Security risks further encompass threats to the competitive advantage, financial stability, or reputation of an innovating entity that may result from the exploitation or leakage of proprietary information.

In the context of the present disclosure, security risks are specifically associated with interactions between innovators and external entities, where the uncertainty, intentions, and capabilities of potential adversaries can significantly influence the likelihood and impact of adverse events. Effective management of such risks requires systematic identification, modeling, quantification, and mitigation to ensure that the benefits of open innovation can be realized without exposing sensitive assets to undue harm.

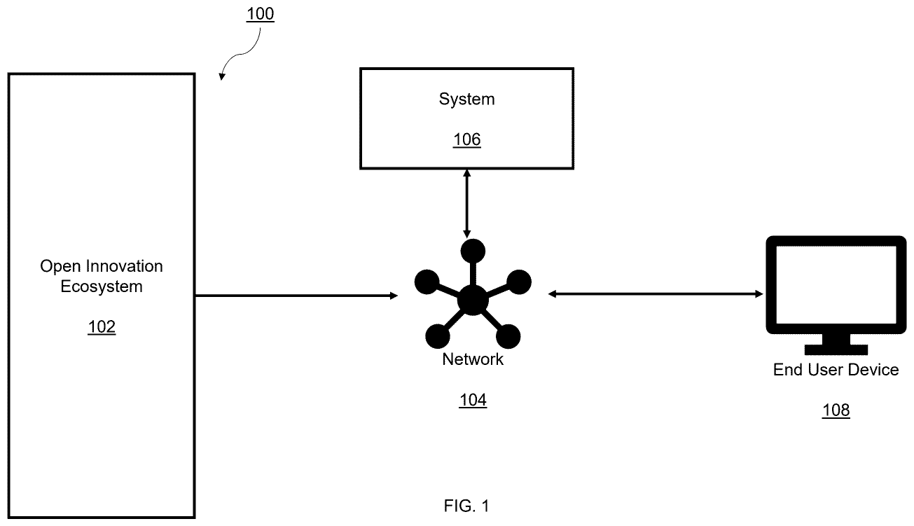

FIG. 1 is a diagram that illustrates an exemplary environment 100 within which various embodiments of the present disclosure may function. Referring to FIG. 1, the environment 100 comprises an open innovation ecosystem 102, a network 104, a system 106, and an end user device 108.

The open innovation ecosystem 102 of the environment 100 refers to a collaborative network or platform in which multiple entities, including organizations, research institutions, startups, individual innovators, and other stakeholders, engage in the creation, exchange, or utilization of knowledge, intellectual property, research data, technological resources, and innovation-related insights. The open innovation ecosystem 102 enables activities such as joint research and development projects, co-creation of products or services, licensing or sharing of patents, crowdsourcing of ideas, and strategic partnerships for technology commercialization. In the context of the present disclosure, the open innovation ecosystem 102 further encompasses scenarios in which sensitive information or proprietary assets may be exposed to potential adversaries, either intentionally or inadvertently, during collaborative interactions. Such exposure introduces security risks that require systematic identification, modeling, quantification, and mitigation, as performed by the system 106 described herein. The open innovation ecosystem 102 may operate across physical and digital spaces, including cloud-based platforms, enterprise networks, research consortiums, or hybrid infrastructures that facilitate communication, data exchange, and collaborative decision-making among participants.

In one exemplary embodiment, the open innovation ecosystem 102 comprises a consortium of technology companies, research universities, and startup incubators collaborating on the development of advanced materials for renewable energy applications. Participants in the ecosystem 102 share experimental data, simulation models, prototype designs, and patent portfolios through a secure digital platform accessible via the network 104. The ecosystem 102 supports both structured collaborations, such as multi-party research agreements with defined roles and responsibilities, and informal exchanges, such as discussion forums and knowledge-sharing workshops. In this embodiment, sensitive data, including proprietary chemical formulations and design schematics, are accessible to authorized collaborators but remain protected from unauthorized access by potential adversaries.

The network 104 in this context refers to one or more communication infrastructures that enable data exchange and connectivity among components of the environment 100, including the open innovation ecosystem 102, the system 106, and the end user device 108. The network 104 may comprise wired and/or wireless communication channels, such as the Internet, intranets, local area networks (LANs), wide area networks (WANs), virtual private networks (VPNs), or cloud-based communication frameworks. In one or more embodiments, the network 104 facilitates secure transmission of sensitive information, intellectual property, research data, and innovation-related insights between participants of the open innovation ecosystem 102 and the system 106, while supporting real-time monitoring, threat detection, and response mechanisms. The network 104 may further incorporate encryption protocols, access control mechanisms, authentication services, and other cybersecurity measures to ensure the confidentiality, integrity, and availability of data exchanged across the ecosystem. By providing a reliable and secure communication medium, the network 104 enables the system 106 to perform comprehensive analysis of security risks, model adversarial interactions, and deliver actionable recommendations to end users via the end user device 108.

The system 106 of the present disclosure refers to a computational and analytical framework configured to analyze, quantify, and mitigate security threats associated with open innovation processes. The system 106 leverages game-theoretic approaches, including two-player zero-sum games and Nash equilibrium computations, in combination with Bayesian models, to devise optimal strategies for security investment, resource allocation, and threat mitigation.

In one or more embodiments, the system 106 introduces an approach for modeling interactions between an innovator (player 1) and a potential adversary (player 2) as a zero-sum game. The system 106 constructs payoff matrices representing outcomes of various combinations of defensive measures by the innovator and adversarial actions, thereby enabling computation of equilibrium strategies that optimize the allocation of security resources under adversarial conditions.

In one or more embodiments, the system 106 integrates mathematical modeling, probabilistic inference, and strategic planning to ensure the security of open innovation activities while minimizing costs associated with defensive measures. Bayesian game-theoretic models are employed to account for uncertainties in adversary behavior, dynamically updating strategies based on incomplete or evolving information. Entropy-based risk assessment is further utilized to quantify the level of uncertainty and potential impact of threats, guiding the prioritization of security investments. By monitoring multiple attack vectors and analyzing historical threat data, the system 106 identifies potential risk patterns and provides actionable recommendations to safeguard intellectual property, sensitive research data, and other innovation assets within the ecosystem 102.

The end user device 108 of the present disclosure refers to any computing or electronic device through which a user, such as an innovator, security analyst, or system administrator, interacts with the system 106 to access, monitor, and manage security-related information within the open innovation ecosystem 102. The end user device 108 may include, but is not limited to, personal computers, laptops, tablets, smartphones, wearable computing devices, or specialized terminals.

In one or more embodiments, the end user device 108 is configured to receive security alerts, risk assessments, and actionable recommendations generated by the system 106, and to display graphical user interfaces, dashboards, or reports that facilitate informed decision-making regarding resource allocation, threat mitigation strategies, and policy implementation. The end user device 108 may also enable users to input parameters, update threat models, configure security policies, or initiate analysis tasks within the system 106. Communication between the end user device 108 and the system 106 occurs via the network 104, which may incorporate secure protocols, authentication mechanisms, and encryption to maintain the confidentiality, integrity, and availability of transmitted data. By providing real-time access to system insights, the end user device 108 allows users to proactively respond to security risks and optimize protective measures across the open innovation ecosystem 102.

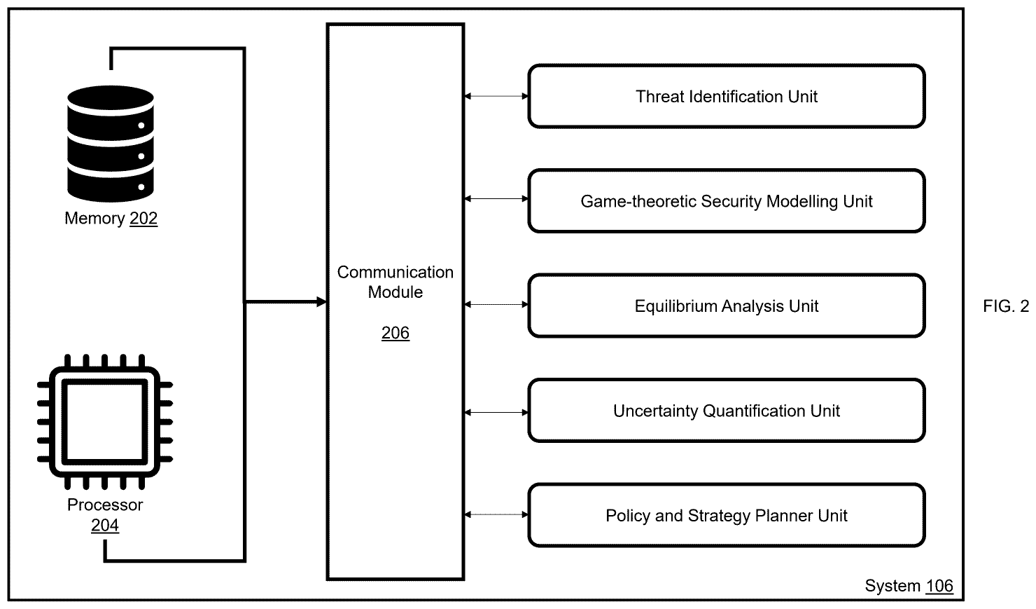

FIG. 2 is a diagram that illustrates the system 106 for analysing and mitigating security risks in an open innovation ecosystem, in accordance with an embodiment of the disclosure. Referring to FIG. 2, the system 106 comprises a memory 202, a processor 204, a communication module 206, a threat identification unit 208, a game-theoretic security modelling unit 210, an equilibrium analysis unit 212, a Bayesian risk modeling unit 214, an uncertainty quantification unit 216, and a policy and strategy planner unit 218.

The memory 202 of the system 106 may comprise volatile and non-volatile memory components, including, but not limited to, random-access memory (RAM), read-only memory (ROM), flash memory, solid-state drives, or other computer-readable storage media. The memory 202 may store instructions, program code, algorithms, historical threat data, payoff matrices, probabilistic models, Bayesian inference parameters, entropy-based risk metrics, and any other data or information required for the operation of the system 106. In one or more embodiments, the memory 202 is configured to enable the storage and retrieval of intermediate and final results generated by the threat identification unit 208, the game-theoretic security modelling unit 210, the equilibrium analysis unit 212, the uncertainty quantification unit 216, and the policy and strategy planner unit 218, thereby facilitating efficient processing and iterative analysis of security risks in the open innovation ecosystem 102.

The processor 204 of the system 106 may comprise one or more processing units, microprocessors, digital signal processors (DSPs), field-programmable gate arrays (FPGAs), or other suitable computational circuitry. The processor 204 may be configured to execute instructions stored in the memory 202 to perform operations associated with security risk analysis, game-theoretic modelling, Bayesian inference, entropy-based risk quantification, and generation of actionable recommendations. In one or more embodiments, the processor 204 controls and coordinates the operation of the threat identification unit 208, the game-theoretic security modelling unit 210, the equilibrium analysis unit 212, the uncertainty quantification unit 216, and the policy and strategy planner unit 218, enabling integrated and automated processing of data and continuous evaluation of potential security threats in the open innovation ecosystem 102.

The communication module 206 of the system 106 may comprise appropriate hardware and software components, including, but not limited to, network interface cards, wireless transceivers, routers, communication protocols, and encryption modules. The communication module 206 is configured to facilitate secure data exchange between the system 106 and the open innovation ecosystem 102, the end user device 108, and other external systems via the network 104. In one or more embodiments, the communication module 206 supports both wired and wireless communication channels, employs authentication and encryption mechanisms to protect data integrity and confidentiality, and enables real-time transmission of threat alerts, risk assessments, and policy recommendations generated by the system 106 to authorized users and devices.

The threat identification unit 208 of the system 106 may comprise suitable hardware, software, logic, and/or interfaces that are configured to detect, collect, and analyze potential vulnerabilities and security threats within the open innovation ecosystem 102.

In one or more embodiments, the threat identification unit 208 monitors various open innovation activities, including, but not limited to, intellectual property exchanges, research data handling, collaborative project workflows, communication between partners, and access to sensitive technological or strategic resources. The threat detection unit 208 may employ automated scanning algorithms, pattern recognition techniques, anomaly detection methods, and historical threat databases to identify potential adversarial actions or system weaknesses.

In one or more non-limiting embodiments, the threat identification unit 208 generates identified threat data that may include details such as the type of threat, source or origin of the threat, likelihood of occurrence, potential impact, and affected assets within the ecosystem 102. This threat data is then provided as input to the game-theoretic security modelling unit 210, enabling computation of optimal defensive strategies, risk quantification, and actionable recommendations for mitigating identified threats.

In an exemplary embodiment, the threat identification unit 208 may continuously monitor multiple collaboration channels and innovation platforms to detect emerging or previously unknown threat patterns. The unit 208 may update a dynamic threat database in real-time, allowing the system 106 to adaptively respond to evolving security risks and maintain a proactive security posture within the open innovation ecosystem 102.

The threat identification unit 208 of the system 106 is further configured to parameterize security risks associated with the open innovation ecosystem 102. In one or more embodiments, the parameterized security risks include, but are not limited to, intellectual property theft, data theft, unauthorized access to research data, or misappropriation of technological resources.

In one or more embodiments, the parameterization of security risks involves assigning attributes such as threat type, source or origin of the threat, likelihood of occurrence, potential impact, affected assets, and criticality level. These attributes allow the system 106 to quantify and categorize each identified risk in a structured format, facilitating systematic analysis and prioritization of mitigation measures.

The parameterized security risks form input to the game-theoretic security modelling unit 210 of the system 106. In one or more embodiments, this integration enables the construction of payoff matrices that represent possible outcomes resulting from combinations of defensive actions by innovators and potential adversarial strategies. By providing structured risk data as input, the threat identification unit 208 ensures that the game-theoretic modelling accurately reflects real-world vulnerabilities and guides the computation of optimal defensive strategies within the ecosystem 102.

In an exemplary, non-limiting embodiment, the threat identification unit 208 may continuously update the parameterized risk data based on new threat intelligence or observed adversarial behavior. This allows the game-theoretic security modelling unit 210 to dynamically adjust strategies and resource allocation to address evolving risks such as novel intellectual property attacks or emerging data theft techniques.

The game-theoretic security modelling unit 210 of the system 106 may comprise suitable logic, code, and/or interfaces that may be configured to represent interactions between an innovator (player 1) and a potential adversary (player 2) as a two-player zero-sum game.

In one or more embodiments, the two-player zero-sum game comprises at least one payoff matrix that encodes the outcomes of various combinations of defensive resource allocations by the innovator and adversarial actions by the adversary. The payoff matrix may quantify benefits, losses, costs, or damages associated with each combination of strategies, thereby providing a structured framework for evaluating optimal defense mechanisms in the open innovation ecosystem 102.

In one or more embodiments, the game-theoretic security modelling unit 210 receives parameterized threat data from the threat identification unit 208, including, but not limited to, intellectual property theft, data theft, unauthorized access, or misappropriation of technological resources. This input ensures that the payoff matrix accurately reflects real-world vulnerabilities and potential impacts, allowing the system 106 to determine optimal resource allocation strategies that minimize risk exposure.

In an exemplary, non-limiting embodiment, the game-theoretic security modelling unit 210 may support multiple payoff matrices corresponding to different types of threats or scenarios within the open innovation ecosystem 102. The unit 210 can iteratively update the matrices based on evolving threat intelligence, observed adversary behavior, or newly identified vulnerabilities, enabling dynamic computation of defensive strategies and proactive security management.

In one or more embodiments, the game-theoretic security modelling unit 210 of the system 106 is configured to formulate a two-player zero-sum game in which the innovator (player 1) represents a defending player and the adversary (player 2) represents an attacking player.

In this configuration, the zero-sum nature of the game implies that the gain of one player corresponds to the loss of the other. For example, a successful defensive action by the innovator reduces the effectiveness of the adversary's attack, whereas a successful adversarial action increases potential losses or damages to the innovator. This formulation allows the system 106 to model strategic interactions and evaluate optimal allocation of defensive resources in response to potential attacks within the open innovation ecosystem 102.

In one or more embodiments, the game-theoretic security modelling unit 210 constructs payoff matrices that represent outcomes associated with each combination of defending and attacking strategies. The payoff values may reflect financial losses, reputational impact, intellectual property risk, data exposure, or other metrics relevant to the security of the ecosystem 102.

In an exemplary, non-limiting embodiment, the unit 210 may update the two-player zero-sum game dynamically based on evolving threat intelligence or updated parameterized risks provided by the threat identification unit 208. This enables the system 106 to continuously adapt defensive strategies and maintain optimal security posture against both known and emerging threats, including intellectual property theft, data breaches, or unauthorized access to sensitive research information.

The equilibrium analysis unit 212 may comprise suitable logic, code, and/or interfaces that may be configured to compute a Nash equilibrium from the payoff matrix generated by the unit 210.

In one or more embodiments, the Nash equilibrium represents an optimal set of strategies for the innovator (defending player) and the adversary (attacking player) such that no player can unilaterally improve their outcome by changing their strategy. By identifying these equilibrium strategies, the system 106 can determine the most effective allocation of defensive resources under adversarial conditions within the open innovation ecosystem 102.

In one or more embodiments, the equilibrium analysis unit 212 may compute multiple Nash equilibria corresponding to different types of threats or varying scenarios, including intellectual property theft, data theft, unauthorized access, or other adversarial actions. Each computed equilibrium provides guidance on optimal investment in security measures and prioritization of protective actions.

In an exemplary, non-limiting embodiment, the equilibrium analysis unit 212 may dynamically update the computed Nash equilibrium based on changes in the parameterized threat data provided by the threat identification unit 208 or updated payoff matrices from the game-theoretic security modelling unit 210. This allows the system 106 to continuously adapt defensive strategies in response to evolving security risks and maintain an optimal security posture across the open innovation ecosystem 102.

In one or more embodiments, the equilibrium analysis unit 212 of the system 106 applies mathematical optimization techniques to the payoff matrix generated by the game-theoretic security modelling unit 210 to compute the Nash equilibrium. The computed Nash equilibrium represents an optimal strategy for the innovator (defending player) and the adversary (attacking player) in which neither player can unilaterally improve their outcome. In this context, the Nash equilibrium balances the costs of defensive investments against the reduction in potential losses or risks, enabling the system 106 to determine resource allocation strategies that optimize security while minimizing expenditure.

In one or more embodiments, the equilibrium analysis unit 212 further employs a machine learning model trained on historical adversary behaviors, attack patterns, and threat outcomes to refine the computation of equilibrium strategies. By leveraging historical data, the unit 212 can predict potential adversarial moves, adjust payoff matrices accordingly, and improve the accuracy and relevance of the recommended defensive strategies for the open innovation ecosystem 102.

In one or more embodiments, the Nash equilibrium computed by the equilibrium analysis unit 212 may also account for multiple types of threats or simultaneous attack scenarios, including intellectual property theft, data theft, or unauthorized access to sensitive information. This multi-dimensional approach enables the system 106 to generate robust, adaptable strategies that remain effective under varying adversarial conditions, ensuring continuous protection of critical innovation assets.

In an exemplary, non-limiting embodiment, the equilibrium analysis unit 212 may periodically recompute the Nash equilibrium in response to updates from the threat identification unit 208 or dynamic changes in the parameterized risk data, payoff matrices, or observed adversary behavior. This allows the system 106 to maintain an adaptive and proactive security posture within the open innovation ecosystem 102, continuously optimizing defensive investments and mitigating emerging threats.

The Bayesian risk modeling unit 214 of the system 106 may comprise suitable hardware, software, logic, and/or interfaces that are configured to model adversary uncertainty using probability distributions and to update equilibrium strategies generated by the equilibrium analysis unit 212 based on incomplete or dynamic information.

In one or more embodiments, the Bayesian risk modeling unit 214 applies principles of Bayesian game theory to update the payoff matrix generated by the game-theoretic security modelling unit 210. The unit 214 utilizes probability distributions representing potential adversary attack strategies to refine defensive strategy computations, allowing the system 106 to adapt to uncertain or evolving threats within the open innovation ecosystem 102.

In one or more embodiments, the Bayesian updating performed by the unit 214 is based on adversary type classification. The adversary type classification may be determined based on one or more of the following factors: adversary capability, adversary intention, or adversary historical behavior. By categorizing adversaries, the system 106 can assign probability values to different attack strategies and adjust defensive measures accordingly.

In one or more embodiments, the Bayesian risk modeling unit 214 further integrates adversary probability distributions with innovator intelligence data, such as historical defense performance, ongoing research sensitivity, and resource allocation patterns, to produce a Bayesian security model. This model enables adaptive strategy generation, allowing the system 106 to proactively adjust defensive investments and optimize resource allocation under dynamic and uncertain conditions.

In an exemplary, non-limiting embodiment, the Bayesian risk modeling unit 214 may continuously update probability distributions and recalibrate equilibrium strategies as new threat intelligence, parameterized risks from the threat identification unit 208, or observed adversary behaviors become available. This continuous updating ensures that the system 106 maintains a robust, adaptive, and proactive security posture within the open innovation ecosystem 102.

The uncertainty quantification unit 216 of the system 106 may comprise suitable hardware, software, logic, and/or interfaces that are configured to evaluate adversary uncertainty using entropy-based risk assessment and to determine levels of security investment resources responsive to the quantified uncertainty.

In one or more embodiments, the uncertainty quantification unit 216 computes Shannon entropy values corresponding to probability distributions generated by the Bayesian risk modeling unit 214, which represent the unpredictability or randomness of adversary strategies within the open innovation ecosystem 102. The entropy values provide a quantitative measure of uncertainty associated with potential attacks, enabling the system 106 to assess the degree of risk exposure for different innovation assets.

In one or more embodiments, higher entropy values, indicating increased unpredictability of adversary behavior, trigger allocation of additional security investment or reinforcement of defensive measures. Conversely, lower entropy values, corresponding to more predictable adversary strategies, may allow for optimized, cost-efficient allocation of security resources.

In an exemplary, non-limiting embodiment, the uncertainty quantification unit 216 may integrate entropy-based assessments with parameterized threat data from the threat identification unit 208 and Bayesian probability updates from the Bayesian risk modeling unit 214. This integration enables the system 106 to generate adaptive, risk-informed strategies that maintain robustness against both known and emerging threats while optimizing resource utilization across the open innovation ecosystem 102.

The policy and strategy planner unit 218 of the system 106 may comprise suitable hardware, software, logic, and/or interfaces that are configured to integrate results from the equilibrium analysis unit 212, the Bayesian risk modeling unit 214, and the uncertainty quantification unit 216 to generate actionable security recommendations. These recommendations may include allocation of security investment, prioritization of protective measures, and guidelines for mitigation strategies within the open innovation ecosystem 102.

In one or more embodiments, the policy and strategy planner unit 218 generates mitigation strategies comprising at least one of the following: allocation of security budgets to critical assets, prioritization of protective technologies or software solutions, modification of procedural safeguards or operational protocols, and establishment of monitoring frameworks to detect and respond to emerging threats. By integrating inputs from preceding units, the planner unit 216 ensures that the recommended strategies are both effective and resource-optimized.

In one or more embodiments, the policy and strategy planner unit 218 further generates guidelines for collaboration agreements between innovators, collaborators, and external partners. These guidelines may include contractual clauses, access control policies, information-sharing protocols, and procedural measures designed to reduce exposure to identified security risks such as intellectual property theft, data breaches, or unauthorized access.

In an exemplary, non-limiting embodiment, the policy and strategy planner unit 218 may periodically update recommended strategies and guidelines based on dynamic updates from the threat identification unit 208, game-theoretic analyses from unit 210, Bayesian probability distributions from unit 214, and entropy-based uncertainty assessments. This allows the system 106 to maintain a proactive and adaptive security posture across the open innovation ecosystem 102, ensuring continuous protection of sensitive assets while supporting collaborative innovation.

In one or more embodiments, the threat identification unit 208, the game-theoretic security modelling unit 210, the equilibrium analysis unit 212, the Bayesian risk modeling unit 214, and the uncertainty quantification unit 216 are integrated into a computational model pool within the system 106.

The computational model pool is configured to iteratively refine defensive strategies based on feedback derived from observed adversary behavior, parameterized threat data, and evolving security conditions within the open innovation ecosystem 102. In this configuration, outputs from each unit including threat identification, payoff matrices, Nash equilibria, Bayesian probability updates, and entropy-based risk assessments are consolidated to inform subsequent rounds of strategy optimization.

In one or more embodiments, the model pool supports adaptive learning, whereby historical adversary behaviors, prior attack patterns, and system response effectiveness are continuously fed back into the integrated units. This allows the system 106 to dynamically adjust payoff matrices, equilibrium computations, Bayesian probability distributions, and uncertainty quantifications to enhance predictive accuracy and optimize resource allocation for security investments.

In an exemplary, non-limiting embodiment, the computational model pool enables the system 106 to simulate multiple attack-defense scenarios, assess potential outcomes under varying levels of adversary sophistication, and iteratively update defensive strategies to maintain robustness against evolving threats. By leveraging this iterative feedback mechanism, the system 106 provides a continuously adaptive and proactive approach to securing intellectual property, research data, and other critical assets in the open innovation ecosystem 102.

In one or more embodiments, the Bayesian risk modeling unit 214 and the equilibrium analysis unit 212 of the system 106 are jointly optimized using deep learning algorithms. This joint optimization enables the system 106 to improve predictive accuracy of potential adversary strategies and the corresponding defensive investments required to mitigate risks within the open innovation ecosystem 102.

In one or more embodiments, the deep learning algorithms may include, but are not limited to, recurrent neural networks (RNNs), convolutional neural networks (CNNs), graph neural networks (GNNs), or transformer-based models. These algorithms are trained on historical adversary behavior, prior attack patterns, and parameterized threat data from the threat identification unit 208 to enhance the system's ability to predict adversarial moves and update payoff matrices, Nash equilibria, and resource allocation strategies accordingly.

In an exemplary, non-limiting embodiment, the joint optimization enables iterative refinement of both Bayesian probability distributions and equilibrium computations. As new threat intelligence or observed adversary behaviors are received, the system 106 adjusts defensive investment strategies in real-time, allowing proactive and adaptive mitigation of security risks, including intellectual property theft, data breaches, or unauthorized access to sensitive research information.

In one or more embodiments, the integration of deep learning-based joint optimization supports scenario simulation and strategy evaluation under multiple threat conditions. This allows the system 106 to generate robust, resource-efficient, and dynamically updated security policies that maintain optimal protection of critical assets within the open innovation ecosystem 102.

### Exemplary Embodiment: Securing a Collaborative Renewable Energy Research Project

In one exemplary embodiment, the open innovation ecosystem 102 comprises a consortium of technology companies, research universities, and startup incubators collaboratively developing advanced battery technologies for renewable energy applications. Participants in the ecosystem 102 exchange research data, prototype designs, simulation models, and patent portfolios. Due to the sensitive nature of the intellectual property and competitive advantage, the system 106 is deployed to analyze and mitigate potential security risks.

Communication Module 206: All data and interactions between ecosystem participants, the system 106, and end user devices 108 are routed through the communication module 206. The module 206 ensures secure transmission via encrypted channels, authenticates users, and logs communications for auditing. In this scenario, researchers upload experimental results and design files to a shared cloud repository, while the communication module 206 monitors access and transfer to prevent unauthorized interception.

Threat Identification Unit 208: The threat identification unit 208 continuously monitors collaboration activities, including file access, intellectual property exchanges, and partner communications. The unit 208 detects anomalies such as unusual download patterns, unauthorized access attempts, or suspicious data transfers. Parameterized security risks are generated for identified threats, including potential intellectual property theft and data exfiltration, along with likelihood, impact, and affected assets. This parameterized threat data forms input to the game-theoretic security modelling unit 210.

Game-Theoretic Security Modelling Unit 210: Using the input from the threat identification unit 208, the game-theoretic security modelling unit 210 constructs a two-player zero-sum game in which the consortium (innovator) is the defending player and potential malicious actors (internal or external adversaries) are the attacking player. The unit 210 prepares payoff matrices representing the outcomes of various defensive strategies versus potential adversarial actions, including costs of implementing encryption, access control, monitoring tools, or procedural safeguards, and potential losses from intellectual property theft or data breaches.

Equilibrium Analysis Unit 212: The equilibrium analysis unit 212 computes the Nash equilibrium from the payoff matrices generated by unit 210. In this scenario, the Nash equilibrium identifies an optimal allocation of security resources, balancing investment costs against potential risk reduction. For example, the system may recommend prioritizing encryption for high-value prototype files while allocating monitoring resources to sensitive experimental datasets. The equilibrium analysis unit 212 may also incorporate deep learning models to refine equilibrium strategies based on historical attack patterns observed in similar research ecosystems.

Bayesian Risk Modeling Unit 214: The Bayesian risk modeling unit 214 updates the payoff matrices and equilibrium strategies based on probability distributions representing adversary capabilities, intentions, and historical behavior. For example, if certain partner networks have previously experienced data breaches, the Bayesian unit 214 increases the probability of targeted attacks on similar data types. The unit 214 integrates this probabilistic information with internal intelligence from the consortium to produce a Bayesian security model that guides adaptive strategy selection.

Uncertainty Quantification Unit 216: The uncertainty quantification unit 216 computes entropy values from the adversary probability distributions to quantify unpredictability of potential attacks. Higher entropy values indicate increased uncertainty, triggering allocation of additional security investments, such as multi-factor authentication for collaborators, enhanced monitoring, and deployment of intrusion detection systems. Lower entropy values allow for cost-efficient allocation of resources to less critical areas.

Policy and Strategy Planner Unit 218: Based on inputs from the equilibrium analysis unit 212, Bayesian risk modeling unit 214, and uncertainty quantification unit 216, the policy and strategy planner unit 218 generates actionable security recommendations. In this scenario, recommendations include allocation of security budgets to high-risk data repositories, prioritization of encryption and access control technologies, establishment of procedural safeguards for research data handling, and guidelines for collaboration agreements that specify partner responsibilities and security protocols. The planner unit 216 ensures that the consortium maintains robust security while enabling effective collaboration.

Iterative Feedback and Model Pool Integration: All units are integrated into a computational model pool, enabling iterative refinement of defensive strategies based on observed adversary behaviors. For example, if an attempted intrusion targeting a prototype design is detected, the threat identification unit 208 flags the event, the Bayesian and game-theoretic units update probability distributions and payoff matrices, the equilibrium analysis unit 212 recomputes optimal strategies, and the planner unit 216 updates mitigation measures accordingly. This continuous feedback loop ensures adaptive and proactive security management across the ecosystem 102.

Outcome: Using the system 106, the consortium achieves a balance between secure collaboration and efficient resource allocation. Intellectual property, sensitive research data, and collaborative innovation activities are protected against both known and emerging adversarial threats, while investment in security measures is optimized for maximum effectiveness.

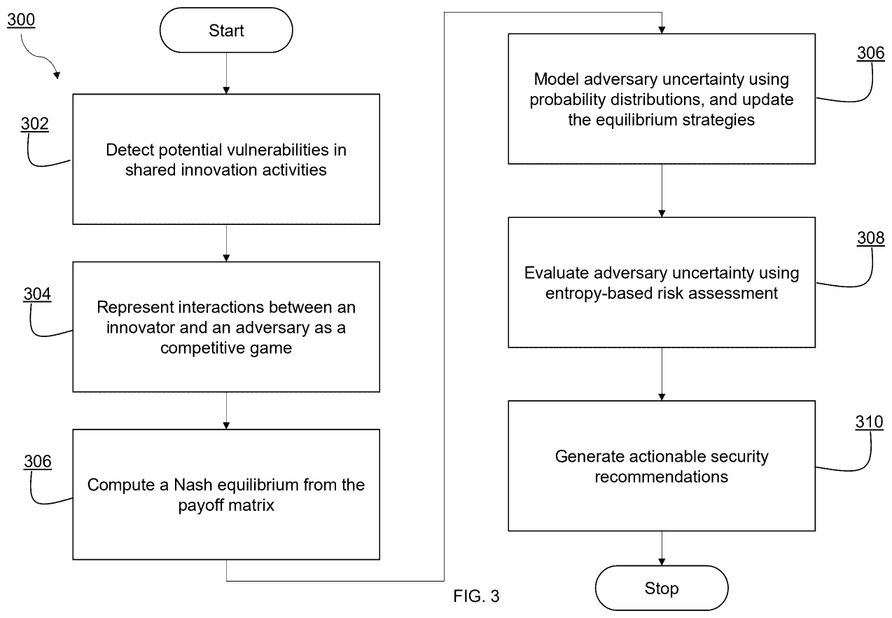

FIG. 3 is a diagram that illustrates a flowchart 300 with a method for analysing and mitigating security risks in open innovation ecosystem, in accordance with an embodiment of the disclosure.

At 302, the threat detection unit 208 detects potential vulnerabilities in shared innovation activities, including intellectual property exchanges, research data handling, and partner collaboration processes.

The threat detection unit 208 may employ automated scanning algorithms, pattern recognition techniques, anomaly detection methods, and historical threat databases to identify potential adversarial actions or system weaknesses.

In one or more non-limiting embodiments, the threat identification unit 208 generates identified threat data that may include details such as the type of threat, source or origin of the threat, likelihood of occurrence, potential impact, and affected assets within the ecosystem 102. This threat data is then provided as input to the game-theoretic security modelling unit 210, enabling computation of optimal defensive strategies, risk quantification, and actionable recommendations for mitigating identified threats.

In an exemplary embodiment, the threat identification unit 208 may continuously monitor multiple collaboration channels and innovation platforms to detect emerging or previously unknown threat patterns. The unit 208 may update a dynamic threat database in real-time, allowing the system 106 to adaptively respond to evolving security risks and maintain a proactive security posture within the open innovation ecosystem 102.

The threat identification unit 208 of the system 106 is further configured to parameterize security risks associated with the open innovation ecosystem 102. In one or more embodiments, the parameterized security risks include, but are not limited to, intellectual property theft, data theft, unauthorized access to research data, or misappropriation of technological resources.

In one or more embodiments, the parameterization of security risks involves assigning attributes such as threat type, source or origin of the threat, likelihood of occurrence, potential impact, affected assets, and criticality level. These attributes allow the system 106 to quantify and categorize each identified risk in a structured format, facilitating systematic analysis and prioritization of mitigation measures.

The parameterized security risks form input to the game-theoretic security modelling unit 210 of the system 106. In one or more embodiments, this integration enables the construction of payoff matrices that represent possible outcomes resulting from combinations of defensive actions by innovators and potential adversarial strategies. By providing structured risk data as input, the threat identification unit 208 ensures that the game-theoretic modelling accurately reflects real-world vulnerabilities and guides the computation of optimal defensive strategies within the ecosystem 102.

In an exemplary, non-limiting embodiment, the threat identification unit 208 may continuously update the parameterized risk data based on new threat intelligence or observed adversarial behavior. This allows the game-theoretic security modelling unit 210 to dynamically adjust strategies and resource allocation to address evolving risks such as novel intellectual property attacks or emerging data theft techniques.

At 304, game-theoretic security modelling unit 210 represents interactions between an innovator and an adversary as a competitive game, the game comprising at least one payoff matrix that encodes outcomes of defensive resource allocations and adversarial actions derived from the detected vulnerabilities.

In one or more embodiments, the two-player zero-sum game comprises at least one payoff matrix that encodes the outcomes of various combinations of defensive resource allocations by the innovator and adversarial actions by the adversary. The payoff matrix may quantify benefits, losses, costs, or damages associated with each combination of strategies, thereby providing a structured framework for evaluating optimal defense mechanisms in the open innovation ecosystem 102.

In one or more embodiments, the game-theoretic security modelling unit 210 receives parameterized threat data from the threat identification unit 208, including, but not limited to, intellectual property theft, data theft, unauthorized access, or misappropriation of technological resources. This input ensures that the payoff matrix accurately reflects real-world vulnerabilities and potential impacts, allowing the system 106 to determine optimal resource allocation strategies that minimize risk exposure.

In an exemplary, non-limiting embodiment, the game-theoretic security modelling unit 210 may support multiple payoff matrices corresponding to different types of threats or scenarios within the open innovation ecosystem 102. The unit 210 can iteratively update the matrices based on evolving threat intelligence, observed adversary behavior, or newly identified vulnerabilities, enabling dynamic computation of defensive strategies and proactive security management.

In one or more embodiments, the game-theoretic security modelling unit 210 of the system 106 is configured to formulate a two-player zero-sum game in which the innovator (player 1) represents a defending player and the adversary (player 2) represents an attacking player.

In this configuration, the zero-sum nature of the game implies that the gain of one player corresponds to the loss of the other. For example, a successful defensive action by the innovator reduces the effectiveness of the adversary's attack, whereas a successful adversarial action increases potential losses or damages to the innovator. This formulation allows the system 106 to model strategic interactions and evaluate optimal allocation of defensive resources in response to potential attacks within the open innovation ecosystem 102.

In one or more embodiments, the game-theoretic security modelling unit 210 constructs payoff matrices that represent outcomes associated with each combination of defending and attacking strategies. The payoff values may reflect financial losses, reputational impact, intellectual property risk, data exposure, or other metrics relevant to the security of the ecosystem 102.

In an exemplary, non-limiting embodiment, the unit 210 may update the two-player zero-sum game dynamically based on evolving threat intelligence or updated parameterized risks provided by the threat identification unit 208. This enables the system 106 to continuously adapt defensive strategies and maintain optimal security posture against both known and emerging threats, including intellectual property theft, data breaches, or unauthorized access to sensitive research information.

At 306, equilibrium analysis unit 212 computes a Nash equilibrium from the payoff matrix, the Nash equilibrium representing optimal defensive investments under adversarial conditions.

In one or more embodiments, the Nash equilibrium represents an optimal set of strategies for the innovator (defending player) and the adversary (attacking player) such that no player can unilaterally improve their outcome by changing their strategy. By identifying these equilibrium strategies, the system 106 can determine the most effective allocation of defensive resources under adversarial conditions within the open innovation ecosystem 102.

In one or more embodiments, the equilibrium analysis unit 212 may compute multiple Nash equilibria corresponding to different types of threats or varying scenarios, including intellectual property theft, data theft, unauthorized access, or other adversarial actions. Each computed equilibrium provides guidance on optimal investment in security measures and prioritization of protective actions.

In an exemplary, non-limiting embodiment, the equilibrium analysis unit 212 may dynamically update the computed Nash equilibrium based on changes in the parameterized threat data provided by the threat identification unit 208 or updated payoff matrices from the game-theoretic security modelling unit 210. This allows the system 106 to continuously adapt defensive strategies in response to evolving security risks and maintain an optimal security posture across the open innovation ecosystem 102.

In one or more embodiments, the equilibrium analysis unit 212 of the system 106 applies mathematical optimization techniques to the payoff matrix generated by the game-theoretic security modelling unit 210 to compute the Nash equilibrium. The computed Nash equilibrium represents an optimal strategy for the innovator (defending player) and the adversary (attacking player) in which neither player can unilaterally improve their outcome. In this context, the Nash equilibrium balances the costs of defensive investments against the reduction in potential losses or risks, enabling the system 106 to determine resource allocation strategies that optimize security while minimizing expenditure.

In one or more embodiments, the equilibrium analysis unit 212 further employs a machine learning model trained on historical adversary behaviors, attack patterns, and threat outcomes to refine the computation of equilibrium strategies. By leveraging historical data, the unit 212 can predict potential adversarial moves, adjust payoff matrices accordingly, and improve the accuracy and relevance of the recommended defensive strategies for the open innovation ecosystem 102.

In one or more embodiments, the Nash equilibrium computed by the equilibrium analysis unit 212 may also account for multiple types of threats or simultaneous attack scenarios, including intellectual property theft, data theft, or unauthorized access to sensitive information. This multi-dimensional approach enables the system 106 to generate robust, adaptable strategies that remain effective under varying adversarial conditions, ensuring continuous protection of critical innovation assets.

In an exemplary, non-limiting embodiment, the equilibrium analysis unit 212 may periodically recompute the Nash equilibrium in response to updates from the threat identification unit 208 or dynamic changes in the parameterized risk data, payoff matrices, or observed adversary behavior. This allows the system 106 to maintain an adaptive and proactive security posture within the open innovation ecosystem 102, continuously optimizing defensive investments and mitigating emerging threats.

At 308, the Bayesian risk modeling unit 214 models adversary uncertainty using probability distributions, and updating the equilibrium strategies based on incomplete or dynamic information.

In one or more embodiments, the Bayesian risk modeling unit 214 applies principles of Bayesian game theory to update the payoff matrix generated by the game-theoretic security modelling unit 210. The unit 214 utilizes probability distributions representing potential adversary attack strategies to refine defensive strategy computations, allowing the system 106 to adapt to uncertain or evolving threats within the open innovation ecosystem 102.

In one or more embodiments, the Bayesian updating performed by the unit 214 is based on adversary type classification. The adversary type classification may be determined based on one or more of the following factors: adversary capability, adversary intention, or adversary historical behavior. By categorizing adversaries, the system 106 can assign probability values to different attack strategies and adjust defensive measures accordingly.

In one or more embodiments, the Bayesian risk modeling unit 214 further integrates adversary probability distributions with innovator intelligence data, such as historical defense performance, ongoing research sensitivity, and resource allocation patterns, to produce a Bayesian security model. This model enables adaptive strategy generation, allowing the system 106 to proactively adjust defensive investments and optimize resource allocation under dynamic and uncertain conditions.

In an exemplary, non-limiting embodiment, the Bayesian risk modeling unit 214 may continuously update probability distributions and recalibrate equilibrium strategies as new threat intelligence, parameterized risks from the threat identification unit 208, or observed adversary behaviors become available. This continuous updating ensures that the system 106 maintains a robust, adaptive, and proactive security posture within the open innovation ecosystem 102.

At 310, the uncertainty quantification unit 216 evaluates adversary uncertainty using entropy-based risk assessment, and to determine levels of security investment resources responsive to the quantified uncertainty.

In one or more embodiments, the uncertainty quantification unit 216 computes Shannon entropy values corresponding to probability distributions generated by the Bayesian risk modeling unit 214, which represent the unpredictability or randomness of adversary strategies within the open innovation ecosystem 102. The entropy values provide a quantitative measure of uncertainty associated with potential attacks, enabling the system 106 to assess the degree of risk exposure for different innovation assets.

In one or more embodiments, higher entropy values, indicating increased unpredictability of adversary behavior, trigger allocation of additional security investment or reinforcement of defensive measures. Conversely, lower entropy values, corresponding to more predictable adversary strategies, may allow for optimized, cost-efficient allocation of security resources.

In an exemplary, non-limiting embodiment, the uncertainty quantification unit 216 may integrate entropy-based assessments with parameterized threat data from the threat identification unit 208 and Bayesian probability updates from the Bayesian risk modeling unit 214. This integration enables the system 106 to generate adaptive, risk-informed strategies that maintain robustness against both known and emerging threats while optimizing resource utilization across the open innovation ecosystem 102.

At 310, policy and strategy planner unit 218 generates actionable security recommendations including allocation of security investment, prioritization of protective measures, and guidelines for mitigation strategies. These recommendations may include allocation of security investment, prioritization of protective measures, and guidelines for mitigation strategies within the open innovation ecosystem 102.

In one or more embodiments, the policy and strategy planner unit 218 generates mitigation strategies comprising at least one of the following: allocation of security budgets to critical assets, prioritization of protective technologies or software solutions, modification of procedural safeguards or operational protocols, and establishment of monitoring frameworks to detect and respond to emerging threats. By integrating inputs from preceding units, the planner unit 216 ensures that the recommended strategies are both effective and resource-optimized.

In one or more embodiments, the policy and strategy planner unit 218 further generates guidelines for collaboration agreements between innovators, collaborators, and external partners. These guidelines may include contractual clauses, access control policies, information-sharing protocols, and procedural measures designed to reduce exposure to identified security risks such as intellectual property theft, data breaches, or unauthorized access.

In an exemplary, non-limiting embodiment, the policy and strategy planner unit 218 may periodically update recommended strategies and guidelines based on dynamic updates from the threat identification unit 208, game-theoretic analyses from unit 210, Bayesian probability distributions from unit 214, and entropy-based uncertainty assessments. This allows the system 106 to maintain a proactive and adaptive security posture across the open innovation ecosystem 102, ensuring continuous protection of sensitive assets while supporting collaborative innovation.

The present system is advantageous in that it provides an integrated computational framework that captures adversary strategies, optimizes security investments, and generates policy-based recommendations in the context of open innovation ecosystems. Unlike conventional approaches that rely on static risk assessment or fragmented security tools, the disclosed system unifies threat identification, game-theoretic modeling, equilibrium analysis, Bayesian risk modeling, and entropy-based uncertainty quantification into a single coherent architecture. This integration enables comprehensive analysis of adversarial behaviors and defensive strategies within collaborative environments where intellectual property, research data, and partner interactions are continuously exchanged.

A further advantage of the present system is that it enables rigorous mathematical representation of adversary and innovator interactions through a two-player zero-sum game, thereby formally capturing adversarial strategies that were previously addressed only through heuristics or reactive policies. By computing Nash equilibria, the system ensures optimal balancing of defensive resource allocations against potential adversarial actions, resulting in technically improved efficiency of security investment. Moreover, the use of Bayesian game theory introduces dynamic adaptation by updating equilibrium strategies in response to incomplete or evolving information, a capability that conventional systems lack.

The present system is further advantageous in that it introduces entropy-based risk quantification to evaluate adversary uncertainty. Through computation of Shannon entropy values, the system measures unpredictability of adversary strategies and adjusts defensive investments accordingly. This technical advancement ensures robustness against uncertain and emerging threats while maintaining cost optimization, which is not achievable through traditional scoring-based risk assessment methods.

Additionally, the policy and strategy planner unit operationalizes outputs from the underlying mathematical and probabilistic models by generating actionable recommendations, including allocation of security budgets, prioritization of protective technologies, modification of procedural safeguards, and establishment of collaboration guidelines. This ensures that complex computational results are translated into enforceable and practical security measures, providing a direct technical benefit in real-world deployment.

Another technical advantage of the system lies in its iterative and adaptive learning capability. By integrating its constituent units into a computational model pool, the system incorporates feedback from observed adversary behavior to iteratively refine equilibrium strategies and probability distributions. This results in a continuously evolving security posture that adapts to adversarial innovation and maintains resilience over time.

The present system is advantageous in that it integrates mathematical modeling with strategic planning to ensure security of innovation while maintaining cost optimization. By employing game-theoretic formulations, the system models the interaction between innovators and adversaries in the form of payoff matrices, enabling optimization of defensive investment strategies. The computation of Nash equilibria allows the system to identify strategies that minimize exposure to adversarial threats while ensuring efficient allocation of security resources.

A further advantage of the present system is that it incorporates Bayesian inference to dynamically update defensive strategies under conditions of incomplete or evolving information. By capturing adversary uncertainty through probability distributions and adversary type classification, the system enhances predictive accuracy and provides adaptive mitigation measures. This technical advancement enables the system to remain resilient against both known and emerging threats in collaborative innovation environments.

The present system also introduces entropy-based risk quantification as a means to evaluate adversary unpredictability. Through computation of Shannon entropy values, the system quantifies levels of uncertainty and adjusts defensive investments accordingly. This ensures robustness against high-uncertainty scenarios, while avoiding unnecessary expenditure in situations of low unpredictability, thereby achieving a balanced and technically optimized security posture.

Another advantage of the system lies in its ability to translate complex computational outputs into actionable policies and strategies. By generating recommendations for allocation of budgets, prioritization of protective technologies, modification of procedural safeguards, and establishment of collaboration guidelines, the system operationalizes mathematical results into practical security frameworks that can be directly implemented in real-world open innovation ecosystems.

It will be appreciated that the embodiments described herein are illustrative and non-limiting in nature. The complete specification may include additional embodiments, modifications, and variations that fall within the scope of the present disclosure. Such alternative embodiments may be devised without departing from the spirit or scope of the invention, and it is intended that the present disclosure encompass all such non-limiting embodiments in addition to those expressly described above.

It will be understood that the advantages described above are merely illustrative and not exhaustive. The present system may provide additional technical benefits and improvements beyond those specifically enumerated, and such advantages are considered to be within the scope of the disclosure.

1. A computer-implemented system for analysing and mitigating security risks in an open innovation ecosystem, comprising:
at least one processor;
a memory communicatively coupled to the processor and storing instructions that, when executed by the processor, configure the system to implement:
a threat identification unit configured to detect potential vulnerabilities in open innovation activities, including intellectual property exchanges, research data handling, and partner collaboration processes, and to provide identified threat data as input;
a game-theoretic security modeling unit coupled to the threat identification unit, the game-theoretic security modeling unit configured to represent interactions between an innovator and an adversary as a two-player zero-sum game, the two-player zero-sum game comprising at least one payoff matrix that encodes outcomes of defensive resource allocations and adversarial actions derived from the identified threat data;
an equilibrium analysis unit coupled to the game-theoretic security modeling unit, the equilibrium analysis unit configured to compute a Nash equilibrium from the payoff matrix, the Nash equilibrium representing optimal defensive investments under adversarial conditions;
a Bayesian risk modeling unit coupled to the equilibrium analysis unit, the Bayesian risk modeling unit configured to model adversary uncertainty using probability distributions, and further configured to update the equilibrium strategies based on incomplete or dynamic information;
an uncertainty quantification unit coupled to the Bayesian risk modeling unit, the uncertainty quantification unit configured to evaluate adversary uncertainty using entropy-based risk assessment, and to determine levels of security investment resources responsive to the quantified uncertainty; and
a policy and strategy planner unit coupled to the uncertainty quantification unit, the policy and strategy planner unit configured to integrate results of the equilibrium analysis, Bayesian risk modeling, and uncertainty quantification to generate actionable security recommendations including allocation of security investment, prioritization of protective measures, and guidelines for mitigation strategies.

2. The system of claim 1, wherein the game-theoretic security modeling unit is configured to formulate a two-player zero-sum game in which the innovator represents a defending player and the adversary represents an attacking player, such that the loss of one corresponds to a gain of the other.

3. The system of claim 1, wherein the threat identification unit is further configured to parameterize security risks including at least intellectual property theft and data theft, the parameterized risks forming input to the game-theoretic modeling unit.

4. The system of claim 1, wherein the equilibrium analysis unit applies mathematical optimization techniques to the payoff matrix to compute the Nash equilibrium, the Nash equilibrium balancing defensive investment costs against risk reduction.

5. The system of claim 1, wherein the Bayesian Risk Modeling unit applies Bayesian game theory to update the payoff matrix based on probability distributions representing adversary attack strategies.

6. The system of claim 5, wherein the Bayesian updating is based on adversary type classification, the adversary type classification being determined by at least one of: adversary capability, adversary intention, or adversary historical behavior.

7. The system of claim 5, wherein the Bayesian risk modeling unit further integrates adversary probability distributions with innovator intelligence data to produce a Bayesian security model for adaptive strategy generation.

8. The system of claim 1, wherein the uncertainty quantification unit computes Shannon entropy values corresponding to adversary probability distributions, the entropy values representing the unpredictability of adversary strategies.

9. The system of claim 1, wherein the policy and strategy planner unit generates mitigation strategies comprising at least one of: allocation of security budgets, prioritization of protective technologies, modification of procedural safeguards, or establishment of monitoring frameworks.

10. The system of claim 1, wherein the threat identification unit, the game-theoretic security modeling unit, the equilibrium analysis unit, the Bayesian risk modeling unit, and the uncertainty quantification unit are integrated into a computational model pool, the model pool configured to iteratively refine defensive strategies using feedback from adversary behavior observations.

11. The system of claim 1, wherein the Bayesian risk modeling unit and the equilibrium analysis unit are jointly optimized using deep learning algorithms to improve predictive accuracy of adversary strategies and corresponding defensive investments.

12. A computer-implemented method for analyzing and mitigating security risks in open innovation ecosystem, the method comprising:
detecting potential vulnerabilities in shared innovation activities, including intellectual property exchanges, research data handling, and partner collaboration processes;
representing interactions between an innovator and an adversary as a competitive game, the game comprising at least one payoff matrix that encodes outcomes of defensive resource allocations and adversarial actions derived from the detected vulnerabilities;
computing a Nash equilibrium from the payoff matrix, the Nash equilibrium representing optimal defensive investments under adversarial conditions;
modeling adversary uncertainty using probability distributions, and updating the equilibrium strategies based on incomplete or dynamic information;
evaluating adversary uncertainty using entropy-based risk assessment, and determining levels of security investment responsive to the evaluated uncertainty; and
generating actionable security recommendations including allocation of security investment, prioritization of protective measures, and guidelines for mitigation strategies.

13. The method of claim 12, wherein representing interactions between the innovator and the adversary comprises formulating a two-player zero-sum game in which the innovator represents a defending player and the adversary represents an attacking player.

14. The method of claim 12, wherein detecting potential vulnerabilities comprises parameterizing risks including at least intellectual property theft and data theft, the parameterized risks forming input to the game representation.

15. The method of claim 12, wherein computing equilibrium strategies comprises applying mathematical optimization techniques to balance defensive investment costs against risk reduction.

16. The method of claim 12, wherein modeling adversary uncertainty comprises applying Bayesian inference to update the payoff matrix based on probability distributions representing adversary attack strategies.

17. The method of claim 16, wherein the Bayesian inference is based on adversary type classification determined by at least one of: adversary capability, adversary intention, or adversary historical behavior.

18. The method of claim 12, further comprising integrating adversary probability distributions with innovator intelligence data to generate an adaptive Bayesian security model.

19. The method of claim 12, wherein evaluating adversary uncertainty comprises computing Shannon entropy values corresponding to adversary probability distributions.

20. The method of claim 12, wherein generating actionable security recommendations comprises producing strategies including at least one of: allocation of security budgets, prioritization of protective technologies, modification of procedural safeguards, or establishment of monitoring frameworks.
